(19) United States
(12) Patent Application Publication
(10) Pub. No.: US 2019/0265733 A1
(43) Pub. Date: Aug. 29, 2019

(54) METHOD AND APPARATUS FOR FLIGHT CONTROL AND AERIAL VEHICLE THEREOF

(71) Applicant: SZ DJI TECHNOLOGY CO., LTD., Shenzhen (CN)

(72) Inventors: You ZHOU, Shenzhen (CN); Peng XIE, Shenzhen (CN); Jiexi DU, Shenzhen (CN)

(21) Appl. No.: 16/406,716

(22) Filed: May 8, 2019

Related U.S. Application Data
(63) Continuation of application No. PCT/CN2016/105339, filed on Nov. 10, 2016.

(51) Int. Cl. G05D 1/10; B64C 39/02; G08G 5/00; B64D 47/08

(52) U.S. Cl. CPC G05D 1/101; B64C 39/024; B64C 2201/146; B64D 47/08; G08G 5/0078

(57) ABSTRACT

The present disclosure provides a method and apparatus for flight control and an aerial vehicle thereof. The flight control used in an aerial vehicle includes the following steps: identifying a reference object in a flight environment; obtaining a distance between the aerial vehicle and the reference object; acquiring a flight strategy corresponding to the distance based on a correspondence between the distance between the aerial vehicle and the reference object and the flight strategy; and, controlling the aerial vehicle to fly based on the flight strategy. The method and apparatus for flight control and an aerial vehicle thereof can be used to perform effective obstacle avoidance.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application is a continuation application of International Application No. PCT/CN2016/105339, filed on Nov. 10, 2016, the entire content of which is incorporated herein by reference.

### TECHNICAL FIELD

The present disclosure relates to the field of communication technology, more specifically, to a method and apparatus for flight control and an aerial vehicle thereof.

### BACKGROUND

An aerial vehicle can identify obstacles by using radar or ultrasonic waves during flight. For example, in a scenario where an aerial vehicle is facing a window or a forest, the aerial vehicle may transmit ultrasonic waves through an ultrasonic device and receive the reflected ultrasonic waves from the window frames or the branches, and the aerial vehicle may identify the window or forest as obstacles. Subsequently, the aerial vehicle may be controlled to maintain in a hovering position such that the aerial vehicle will not be able to pass through scenes such as windows or trees and will not be able to effectively avoid obstacles.

### SUMMARY

The present disclosure provides a method and apparatus for flight control and an aerial vehicle thereof, which can effectively achieve obstacle avoidance.

One aspect of the present disclosure provides a flight control method used in an aerial vehicle. The flight control method includes the following steps: identifying a reference object in a flight environment; obtaining a distance between the aerial vehicle and the reference object; acquiring a flight strategy corresponding to the distance based on a correspondence between the distance between the aerial vehicle and the reference object and the flight strategy; and, controlling the aerial vehicle to fly based on the flight strategy.

Another aspect of the present disclosure provides a flight control method of used in an aerial vehicle. The flight control method includes the following steps: establishing a communication connection with a control device; receiving a shutdown command for the obstacle avoidance mode transmitted by the control device through the communication connection with the control device, the shutdown command being generated when the control device detects a clicking operation of a button by a user; and, switching off the obstacle avoidance mode in response to the shutdown command.

Another aspect of the present disclosure provides an aerial vehicle having a first input device, a second input device, an output device, a memory for storing computer executable instructions, and a processor to execute the computer executable instructions stored in the memory to perform the following steps: identifying a reference object in a flight environment; obtaining a distance between the aerial vehicle and the reference object; acquiring a flight strategy corresponding to the distance based on a correspondence between the aerial vehicle and the reference object and the flight strategy; and, controlling the aerial vehicle to fly based on the flight strategy.

Another aspect of the present disclosure provides a flight control apparatus. The flight control device includes a communication connection establishing module for establishing a communication connection with a control device; a shutdown command receiving module for receiving a shutdown command for an obstacle avoidance mode transmitted by the control device through the communication connection, the shutdown command being generated when the control device detects a clicking operation of a button; and, an obstacle avoidance mode turning off module for switching off the obstacle avoidance mode in response to the shutdown command.

In the embodiments of the present disclosure, the aerial vehicle may identify a reference object in a flight environment in which the aerial vehicle is located, obtain a distance between the aerial vehicle and the reference object, acquire a flight strategy corresponding to the distance based on a pre-established correspondence between the distance between the aerial vehicle and the reference object and a flight speed, and control the aerial vehicle to fly based on the flight strategy to achieve effective obstacle avoidance.

### BRIEF DESCRIPTION OF THE DRAWINGS

In order to illustrate the technical solutions in the embodiments of the present disclosure or the existing arts more clearly, hereafter, the drawings need to be used in the description of the embodiments or the existing arts will be described simply, obviously, the drawings described below are only some embodiments of the present disclosure, for one ordinary skilled person in the art, other drawings can be obtained according to these drawings.

FIG. 1 is a schematic flowchart of a flight control method according to an embodiment of the present disclosure;

FIG. 2 is a schematic flowchart of a flight control method according to another embodiment of the present disclosure;

FIG. 3 is a schematic flowchart of a flight control method according to another embodiment of the present disclosure;

FIG. 4 is a schematic flowchart of a flight control method according to another embodiment of the present disclosure;

FIG. 5 is a schematic flowchart of a flight control method according to another embodiment of the present disclosure;

FIG. 6 is a schematic diagram of an image interface according to an embodiment of the present disclosure;

FIG. 7 is a schematic diagram of an interface of a bilateral filtering function according to an embodiment of the present disclosure;

FIG. 8 is a schematic structural diagram of a flight control apparatus according to an embodiment of the present disclosure;

FIG. 9 is a schematic structural diagram of an aerial vehicle according to an embodiment of the present disclosure;

FIG. 10 is a schematic structural diagram of a flight control apparatus according to another embodiment of the present disclosure; and,

FIG. 11 is a schematic structural diagram of an aerial vehicle according to another embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

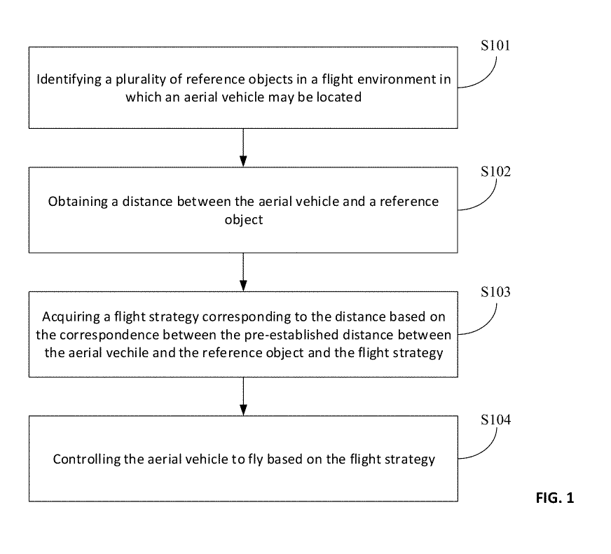

An embodiment of the present disclosure provides a flight control method. Referring to FIG. 1, which is a schematic flowchart of a flight control method according to an embodiment of the present disclosure. As shown in FIG. 1, the flight control method in the present embodiment may include at least the following steps:

Step S101, identifying a reference object in a flight environment in which an aerial vehicle may be located.

The aerial vehicle may identify the reference object in the flight environment in which the aerial vehicle may be located. In particular, the flight environment in which the aerial vehicle may be located may include flying at a low altitude over rough terrain, passing through a narrow space such as a window or a door frame, etc. The narrow space may refer to a limited space with small dimensions and limited clearance, such as a void portion in a forest or a group of buildings. The reference object may include the ground, windows, door frames, trees, buildings, or the like. For example, when the aerial vehicle is flying at a low altitude over rough terrain, the reference object in the flight environment may be the ground; when the aerial vehicle is passing through a window or a door frame, the reference object in the flight environment may be the door or the door frame; when the aerial vehicle is passing through a narrow space, the reference object in the flight environment may be a tree, a building, or the like.

Step S102, obtaining a distance between the aerial vehicle and the reference object.

After the aerial vehicle identifies the reference object in the flight environment in which the aerial vehicle may be located, the distance between the aerial vehicle and the reference object may be obtained. For example, the aerial vehicle may obtain a flight height of the aerial vehicle relative to the ground, a longitudinal distance between the aerial vehicle and the door frame or the window, or a lateral distance between the aerial vehicle and the trees or the buildings.

In some embodiments, the aerial vehicle may acquire a first image through a first camera, where the first image may include the ground. Further, the aerial vehicle may analyze the acquired first image to obtain a flight height of the aerial vehicle relative to the ground.

In some embodiments, the aerial vehicle may analyze the acquired first image to obtain the flight height of the aerial vehicle relative to the ground. More specifically, a reference line of the ground and an end line thereof in the acquired first image may be determined, a distance between the reference line and the end line may be obtained, the flight height corresponding to the distance may be obtained based on a pre-established correspondence between the distance between the reference line and the end line and the flight height, and the flight height corresponding to the distance may be used as the flight height of the aerial vehicle relative to the ground.

In some embodiments, the first camera may be located directly below the aerial vehicle, and the aerial vehicle may analyze the first image to obtain the flight height of the aerial vehicle relative to the ground. More specifically, a flight position of the aerial vehicle may be obtained by a preset position sensor, the acquired image may be analyzed based on the flight position of the aerial vehicle, and the flight height of the aerial vehicle relative to the ground may be calculated.

In some embodiments, the aerial vehicle may obtain the distance between the aerial vehicle and the reference object. More specifically, historical distances obtained between the aerial vehicle and the reference object collected in a predetermined time period may be calculated, and the historical distances may be processed by using a preset bilateral filter to obtain a current distance between the aerial vehicle and the reference object.

In some embodiments, before the aerial vehicle processes the historical distances by using the preset bilateral filter to obtain the current distance between the aerial vehicle and the reference object, a historical filtering result and a current velocity vector of the aerial vehicle may be obtained, a predicted value may be calculated based on the historical filtering result and the velocity vector, and a preset bilateral filtering function may be offset. In particular, the confidence probability corresponding to the predicted value in the post-offset preset bilateral filtering function may be the maximum confidence probability.

In some embodiments, the aerial vehicle may process the historical distances through the preset bilateral filter to obtain the current distance between the aerial vehicle and the reference object. More specifically, an expected value between each historical distance and the predicted value may be obtained, a confidence probability corresponding to each expected value may be obtained based on the post-offset preset bilateral filtering function, and the confidence probability corresponding to each expected value may be normalized to obtain the current distance between the aerial vehicle and the reference object.

In some embodiments, in response to detecting the aerial vehicle being in a shuttle mode, the aerial vehicle may obtain a lateral distance between the aerial vehicle and the reference object by using a preset sensor.

In some embodiments, before the aerial vehicle obtains the distance between the aerial vehicle and the reference object, it may determine whether the aerial vehicle is in an obstacle avoidance mode.

Step S103, acquiring a flight strategy corresponding to the distance based on the correspondence between a pre-established distance between the aerial vehicle and the reference object and the flight strategy.

The aerial vehicle may pre-establish a correspondence between the distance and the flight strategy, and the flight strategy may include flight speed, flight position, etc. For example, the aerial vehicle may establish a correspondence between the distance and the flight speed in advance, and the distance and the flight speed may have a linear relationship. In one example, the slope between the distance and the flight speed may be 0.5 m. If the distance between the aerial vehicle and the reference object obtained by the aerial vehicle is 1 m, the flight speed corresponding to the distance obtained by the aerial vehicle may be 2 m/s.

In some embodiments, after the aerial vehicle analyzes the acquired first image to obtain the flight height of the aerial vehicle relative to the ground, the flight speed corresponding to the flight height may be obtained based on a pre-established correspondence between the flight height of the aerial vehicle relative to the ground and the flight speed.

In some embodiments, after the aerial vehicle processes the historical distances by using the preset bilateral filter to obtain the current distance between the aerial vehicle and the reference object, the flight speed corresponding to the current distance may be obtained based on the pre-established correspondence between the distance between the aerial vehicle and the reference object and the flight speed.

In some embodiments, after the aerial vehicle obtains the lateral distance between the aerial vehicle and the reference object through the preset sensor, the flight speed corresponding to the lateral distance may be obtained based on the pre-established correspondence between the lateral distance and the flight speed.

Step S104, controlling the aerial vehicle to fly based on the flight strategy.

The aerial vehicle may control the aerial vehicle to fly based on the acquired flight strategy, such as controlling the aerial vehicle to fly based on the acquired speed, controlling the aerial vehicle to fly based on the acquired flight position, or the like.

In some embodiments, the aerial vehicle may reduce the Field of View (FOV) of a second camera in the aerial vehicle in response to the distance between the aerial vehicle and the reference object being within a predetermined distance range such that the reduced FOV of the second camera may match the size of the aerial vehicle. A second image may be acquired by the second camera based on the reduced FOV of the second camera, and the aerial vehicle may be controlled to stop flying in response to the second image having the reference object. Further, the aerial vehicle may be controlled to remain in flight in response to the second image not having the reference object. In particular, the second camera may be disposed directly in front of the aerial vehicle, and the second camera may be used to view the objects in front of the aerial vehicle.

In some embodiments, the aerial vehicle may reduce the FOV of the second camera in the aerial vehicle. More specifically, the FOV corresponding to the distance may be acquired based on the pre-established correspondence between the distance between the aerial vehicle and the reference object and the FOV, and the FOV of the second camera may be updated so that the updated FOV may be the same as the acquired FOV.

In some embodiments, the aerial vehicle may establish a communication connection with a control device, and receive a shutdown command for the obstacle avoidance mode transmitted by the control device through the communication connection with the control device. In particular, the shutdown command may be generated when the control device detects a user's click operation on a preset button in the control device, and the obstacle avoidance mode may be turned off in response to the shutdown command.

In some embodiments, the aerial vehicle may generate the shutdown command for the obstacle avoidance mode in response to detecting the aerial vehicle is in the shuttle mode, and the obstacle avoidance mode may be turned off in response to the shutdown command.

In the flight control method shown in FIG. 1, the reference object in the flight environment in which the aerial vehicle may be located may be identified, the distance between the aerial vehicle and the reference object may be obtained based on the pre-established correspondence between the distance between the aerial vehicle and the reference object and the flight strategy, the flight strategy corresponding to the distance may be acquired, and the aerial vehicle may be controlled to fly based on the flight strategy to effectively achieve obstacle avoidance.

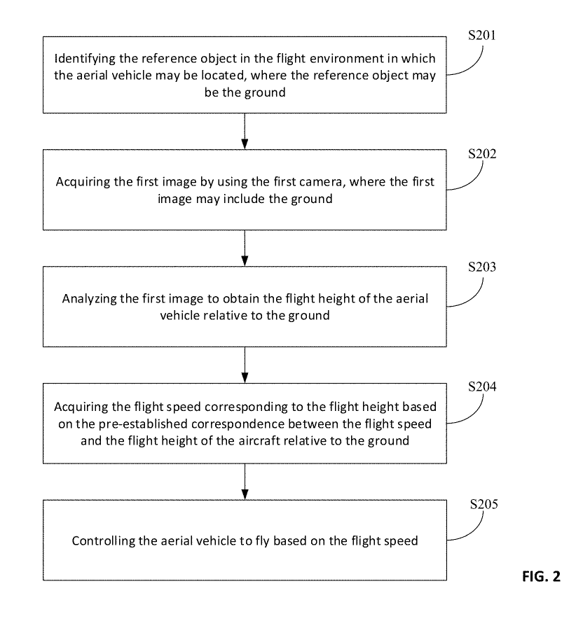

Another embodiment of the present disclosure further provides a flight control method. For example, the flight control method may be applied to the scenario of low-altitude flight over rough terrain. Referring to FIG. 2, which is a schematic flowchart of a flight control method according to another embodiment of the present disclosure. As shown in FIG. 2, the flight control method in the present embodiment may include at least the following steps:

Step S201, identifying the reference object in the flight environment in which the aerial vehicle may be located, where the reference object may be the ground.

In one embodiment, when the aerial vehicle is flying at a low altitude over rough terrain, the aerial vehicle may determine that the reference object in the flight environment in which the aerial vehicle may be located as the ground below the horizontal plane of the aerial vehicle.

Step S202, acquiring the first image by using the first camera, where the first image may include the ground.

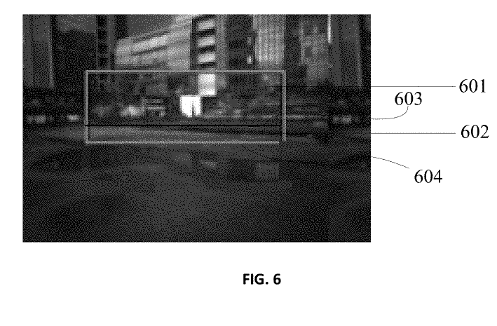

In one embodiment, the first camera may be used to film the scene directly below the aerial vehicle. For example, the first camera may be disposed directly below the aerial vehicle, on the left or right wing of the aerial vehicle, or the like. In some embodiments, the aerial vehicle may also configure the inclination angle of the aerial vehicle. When the aerial vehicle is in the same position, the first image acquired by the first camera at different inclination angles may include different ground areas. Taking the image interface shown in FIG. 6 as an example, during the flight, the first image may be acquired by the first camera and the acquired first image 601 may be as shown in FIG. 6, where the first image may include the ground, and the ground area 602 included in the first image may be as shown in FIG. 6.

In some embodiments, before the aerial vehicle acquires the first image through the first camera, it may determine whether the aerial vehicle is in the obstacle avoidance mode.

Step S203, analyzing the first image to obtain the flight height of the aerial vehicle relative to the ground.

In some embodiments, the aerial vehicle may determine the reference line of the ground and its end line in the first image, obtain the distance between the reference line and the end line, acquire the flight height corresponding to the distance based on the pre-established correspondence between the distance between the reference line and the end line and the flight height, and use the flight height corresponding to the distance as the flight height of the aerial vehicle relative to the ground. In particular, the reference line may be a borderline between the ground and the objects in the first image, and the end line may be an edge line of the first image. Taking the image interface shown in FIG. 6 as an example, after the aerial vehicle acquires the first image through the first camera, the ground reference line 603 and its end line 604 may be determined in the first image. The reference line 603 may be the borderline between the ground and the trees in the first image, and the end line 604 may be the edge line of the first image 601. The aerial vehicle may obtain the distance between the reference line 603 and the end line 604. When the distance between the reference line 603 and the end line is 1 m, the aerial vehicle may determine the current flight height of the aerial vehicle is 10 m based on the pre-established correspondence between the distance and the flight height. In some embodiments, the correspondence between the distance and the flight height at different inclination angles may be different and the aerial vehicle may determine the inclination angle of the first camera. After the aerial vehicle obtains the distance between the reference line and the end line, the flight height corresponding to the distance may be determined based on the pre-established correspondence between the reference line and the end line and the flight height at the inclination angle, and the flight height corresponding to the distance may be used as the flight height of the aerial vehicle relative to the ground.

In some embodiments, the first camera may be located directly below the aerial vehicle, and the aerial vehicle may use the preset position sensor to obtain the flight position of the aerial vehicle. The first image may be analyzed based on the flight position of the aerial vehicle to calculate the flight height of the aerial vehicle relative to the ground. In particular, the flight position may include the inclination angle of the aerial vehicle, the flight speed of the aerial vehicle, or the like.

Step S204, acquiring the flight speed corresponding to the flight height based on the pre-established correspondence between the flight height of the aerial vehicle relative to the ground and the flight speed.

The aerial vehicle may pre-establish the correspondence between the flight height of the aerial vehicle relative to the ground and the flight speed. After acquiring the flight height of the aerial vehicle relative to the ground, the aerial vehicle may acquire the flight speed corresponding to the flight height. For example, the flight height and the flight speed may be proportional to each other, such that when the flight height is 10 m, the corresponding flight speed may be 10 m/s, and when the flight height is 5 m, the corresponding flight speed may be 5 m/s. That is, the lower the current flight height of the aerial vehicle, the slower the flight speed of the aerial vehicle, so the safety of the aerial vehicle may be improved when flying at a low altitude over rough terrain; the higher the current flight height of the aerial vehicle, the faster the flight speed of the aerial vehicle, so the flight efficiency of the aerial vehicle may be improved. In addition, the aerial vehicle may acquire the current flight height of the aerial vehicle relative to the ground by acquiring images in real time, and adjust the flight speed of the aerial vehicle based on the pre-established correspondence between the flight height of the aerial vehicle relative to the ground and the flight speed to achieve a smooth transition of the flight speed to avoid rapid acceleration or deceleration of the aerial vehicle during flight, thereby improving the safety of the aerial vehicle during flight.

Step S205, controlling the aerial vehicle to fly based on the flight speed.

After the aerial vehicle acquires the flight speed corresponding to the flight height, the flight speed of the aerial vehicle may be adjusted to control the aerial vehicle to fly based on the flight speed. In the conventional flight control method, after the first image is acquired by the first camera, the ground area in the first image may be deleted, and the height of the aerial vehicle relative to the ground obtained by analyzing the first image may be higher than the actual height. Thus, when the flight speed of the aerial vehicle is fast, it may be difficult to effectively avoid protruding ground when flying at a low altitude. The embodiment of the present disclosure may automatically reduce the flight speed when the aerial vehicle is at a relatively low altitude relative to the ground, so the flight control efficiency may be improved without user adjustment.

In some embodiments, the aerial vehicle may establish a communication connection with a control device, and receive a shutdown command for the obstacle avoidance mode transmitted by the control device through the communication connection with the control device. In particular, the shutdown command may be generated when the control device detects a user's click operation on a preset button in the control device, and the obstacle avoidance mode may be turned off in response to the shutdown command. In particular, the control device may include a remote controller or a mobile phone, and the control device may be used to control the aerial vehicle. More specifically, turning off the obstacle avoidance mode may include: the aerial vehicle stops acquiring the first image through the first camera and stops controlling the aerial vehicle to fly based on the acquired flight speed. In one embodiment, when the aerial vehicle acquires that the flight speed of the aerial vehicle relative to the ground is relatively slow by analyzing the first image and the user wants to maintain the flight speed of the aerial vehicle, the user may click a button on the control device designated to turn off the obstacle avoidance mode. After the control device receives the shutdown command for the obstacle avoidance mode, the shutdown command may be transmitted to the aerial vehicle through the communication connection, and the aerial vehicle may turn off the obstacle avoidance mode in response to the shutdown command.

In some embodiments, the aerial vehicle may generate the shutdown command for the obstacle avoidance mode in response to detecting the aerial vehicle is in the shuttle mode, and the obstacle avoidance mode may be turned off in response to the shutdown command. In one embodiment, when the aerial vehicle is flying in a narrow space, the aerial vehicle may determine that it is currently in the shuttle mode, and it may generate a shutdown command for the obstacle avoidance mode. The obstacle avoidance mode may be turned off in response to the shutdown command. In particular, the narrow space may be a forest or a group of buildings.

In the flight control method shown in FIG. 2, the aerial vehicle may identify the reference object in the flight environment in which the aerial vehicle may be located, where the reference object may be the ground. The aerial vehicle may further acquire the first image using the first camera; analyze the first image to obtain the flight height of the aerial vehicle relative to the ground; acquire the flight speed corresponding to the flight height based on the pre-established correspondence between the flight height and the flight speed; and control the aerial vehicle to fly based on the flight speed to effectively achieve obstacle avoidance.

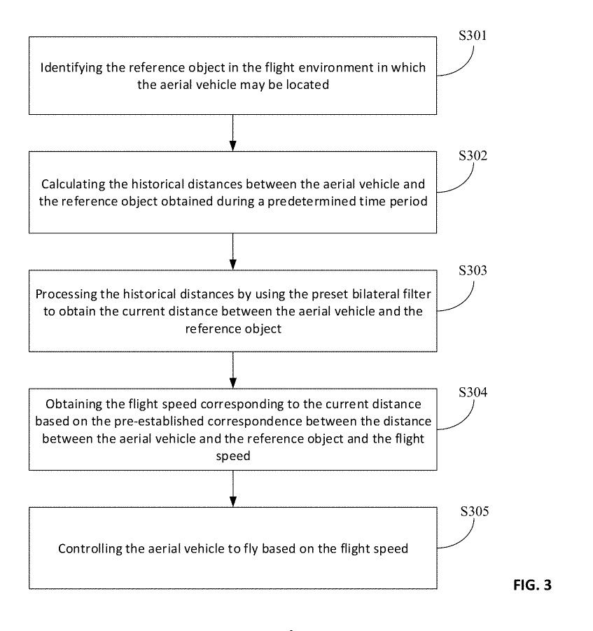

Another embodiment of the present disclosure further provides a flight control method. For example, the flight control method may be applied to the scenarios of passing through windows or door frames. Referring to FIG. 3, which is a schematic flowchart of a flight control method according to another embodiment of the present disclosure. As shown in FIG. 3, the flight control method in the present embodiment may include at least the following steps:

Step S301, identifying the reference object in the flight environment in which the aerial vehicle may be located.

In one embodiment, when the aerial vehicle is passing through a window or a door frame, the reference object in the flight environment in which the aerial vehicle may be located may be identified, where the reference object may include the window, the door frame, or the like.

In some embodiments, after identifying the reference object in the flight environment in which the aerial vehicle may be located, the aerial vehicle may reduce the FOV of the second camera in response to the distance between the aerial vehicle and the reference object being within the predetermined distance range such that the FOV of the reduced second camera may match the size of the aerial vehicle, the second image may be acquired by the second camera based on the FOV of the reduced second camera, and the aerial vehicle may be controlled to stop flying in response to the second image having the reference object. Further, the aerial vehicle may be controlled to remain in flight in response to the second image not having the reference object. In particular, the predetermined distance range may be a predetermined distance interval, such as [10 m, 20 m], [5 m, 15 m], or the like. Furthermore, the second camera may be disposed directly in front of the aerial vehicle, and the second camera may be used to view the objects in front of the aerial vehicle. It should be noted that the reduced FOV of the second camera controlled by the aerial vehicle may match the size of the aerial vehicle. That is, the aerial vehicle may ensure the FOV of the reduced second camera may match the size of the aerial vehicle, that is, the range of viewing angles of the second camera may be the viewing angles of the aerial vehicle passing through the window or the door frame.

In one embodiment, when the aerial vehicle flies near a reference object such as a window or a door frame, the aerial vehicle may detect whether the distance between the aerial vehicle and the reference object is within the predetermined distance range. When the distance between the aerial vehicle and the reference object is within the predetermined distance range, the aerial vehicle may reduce the FOV of the second camera in the aerial vehicle to ensure the reduce FOV of the second camera matches to the size of the aerial vehicle, that is, the viewing angle of the second camera may be the viewing angle of the aerial vehicle passing through the window or the door frame. After the second camera obtains the second image based on the reduce FOV of the second camera by using the second camera, the aerial vehicle may detect whether the second image includes the reference object such as the window or the door frame. When the second image includes the reference object, the aerial vehicle may determine that the size of the window or door frame is small, and the aerial vehicle cannot pass through the window or the door frame, so the aerial vehicle may be controlled to stop flying. When the second image does not include the reference object, the aerial vehicle may determine that the size of the window or the door frame is big, and the aerial vehicle can pass through the window or the door frame, so the aerial vehicle may be controlled to remain in flight.

In some embodiments, the aerial vehicle may reduce the FOV of the second camera in the aerial vehicle. More specifically, the FOV corresponding to the distance may be acquired based on the pre-established correspondence between the distance between the aerial vehicle and the reference object and the FOV, and the FOV of the second camera may be updated so that the updated FOV may be the same as the acquired FOV.

In one embodiment, the aerial vehicle may pre-establish the correspondence between the distance between the aerial vehicle and the reference object and the FOV based on the size of the aerial vehicle. For example, when the distance between the aerial vehicle and the reference object is 10 m, the corresponding FOV may be 60°; and when the distance between the aerial vehicle and the reference object is 15 m, the corresponding FOV may be 30°. Further, in response to the distance between the aerial vehicle and the reference object being within the predetermined distance range, the aerial vehicle may acquire the FOV corresponding to the distance based on the pre-established correspondence between the distance between the aerial vehicle and the reference object and the FOV, and the FOV of the second camera may be updated so the updated FOV may be the same as the acquired FOV.

In some embodiments, before the aerial vehicle acquires the distance between the aerial vehicle and the reference object, it may determine whether the aerial vehicle may be in the obstacle avoidance mode.

Step S302, calculating the historical distances between the aerial vehicle and the reference object obtained during a predetermined time period.

The aerial vehicle may calculate the historical distances between the aerial vehicle and the reference object obtained in the predetermined time period, where the predetermined time period may be a predetermined time duration, such as a time interval of 3s less than or equal to the current system time.

Step S303, processing the historical distances by using the preset bilateral filter to obtain the current distance between the aerial vehicle and the reference object.

In some embodiments, the aerial vehicle may process the historical distances by using the preset bilateral filter. Before obtaining the current distance between the aerial vehicle and the reference object, a historical filtering result and a current velocity vector of the aerial vehicle may be obtained, a predicted value may be calculated based on the historical filtering result and the velocity vector, and the preset bilateral filtering function may be offset. In particular, the confidence probability corresponding to the predicted value in the preset bilateral filtering function after the offset may be the maximum confidence probability.

For example, the preset bilateral filtering function may be a skew normal distribution:

$$f ( x ) = \frac{1}{ω} \sqrt{\frac{2}{π}} {e}^{- \frac{{( x - ξ )}^{2}}{2 {ω}^{2}}} {\int }_{- ∞}^{- α ( \frac{x - ξ}{ω} )} {e}^{- \frac{{t}^{2}}{2}} dt ,$$

where x may be the observed value, that is, the distance between the aerial vehicle and the reference object, and f(x) may be the confidence probability. The left side of the preset bilateral filtering function may be relatively flat, and the confidence probability between two adjacent points may be small; the right side of the preset bilateral filtering function may be relatively steep, and the confidence probability between the two adjacent points may be large. In another example, the aerial vehicle may determine that the most recent historical filtering results obtained may be 5 m, the current speed of the aerial vehicle may be 1 m/s, and the time interval for obtaining the filtering result may be ls. The aerial vehicle may then multiply the current speed of the aerial vehicle by the time interval and subtract the multiplication result from the historical filtering result to obtain the predicted value, that is, 5−1*1=4 m. Further, the aerial vehicle may offset the preset bilateral filtering function such that the confidence probability corresponding to the predicted value in the post-offset preset bilateral filtering function may be the maximum confidence probability.

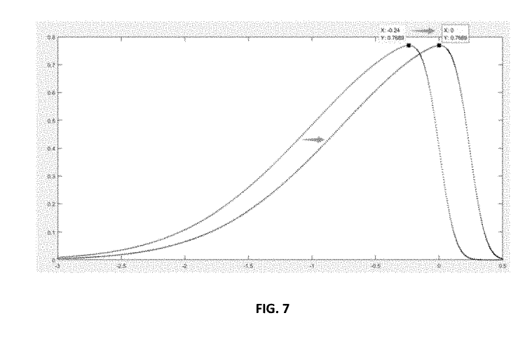

In some embodiments, the aerial vehicle may acquire a plurality of observation intervals and a plurality of sample intervals of the preset bilateral filtering function. For any observation interval, the observation value in the observation interval may be sampled based on the sampling interval corresponding to the observation interval to obtain one or more observation values. The confidence probability corresponding to each of the observation values may be obtained, and the preset bilateral filtering function may be offset based on the observation value corresponding to the maximum confidence probability. Taking the interface diagram of the bilateral filtering function shown in FIG. 7 as an example, when the observation interval is [3, −0.18], the difference in confidence probability between adjacent points may be small, so the aerial vehicle may configure the sampling interval corresponding to the observation interval to be longer, such as sampling the observation values in the observation interval at a sampling interval of 0.01 to obtain one or more observation values. Further, when the observation interval is [−0.18, 0.5], the difference in confidence probability between adjacent points may be large, so the aerial vehicle may configure the sampling interval corresponding to the observation interval to be shorter, such as sampling the observation values in the observation interval at a sampling interval of 0.003 to obtain one or more observation values. The aerial vehicle may determine that the observation value corresponding to the maximum confidence probability of the sampled observation values is −0.24, and the aerial vehicle may offset the preset bilateral filtering function, that is, using ξ=−0.24 to offset the preset bilateral filtering function to the right.

In some embodiments, the aerial vehicle may process the historical distances by using the preset bilateral filtering function to obtain the current distance between the aerial vehicle and the reference object. More specifically, the aerial vehicle may obtain an expected value between the each historical distance and the predicted value, obtain the confidence probability corresponding to each expected value based on the post-offset preset bilateral filtering function, and normalize the confidence probability corresponding to each expected value to obtain the current distance between the aerial vehicle and the reference object.

In some embodiments, the aerial vehicle may obtain an estimated current distance between the aerial vehicle and the reference object based on the most recent obtained distance between the aerial vehicle and the reference object, flight speed, and time interval between each historical distance. Further, the aerial vehicle may obtain the difference between each historical distance and the estimated current distance, obtain the confidence probability corresponding to each difference based on the post-offset preset bilateral filtering function, and normalize each historical distance and its corresponding confidence probability to obtain the current distance between the aerial vehicle and the reference object. For example, the most recent obtained distance between the aerial vehicle and the reference object may be 5 m, the flight speed may be 1 m/s, the time interval may be 1 s, then the aerial vehicle may determine the estimated current distance between the aerial vehicle and the reference object may include be: 5−1*1=4 m, where a first historical distance acquired may be 3 m, the second historical distance acquired may be 5 m, and the third historical distance acquired may be 7 m. The aerial vehicle may further obtain the difference between the first historical distance and the estimated current distance to be −1 m, the difference between the second historical distance and the estimated current distance to be 1 m, and the difference between the third historical distance and the estimated current distance to be 3 m, where a first confidence probability corresponding to the difference between the first historical distance and the estimate current distance may be 0.7, a second confidence probability corresponding to the difference between the second historical distance and the estimate current distance may be 0.3, and a third confidence probability corresponding to the difference between the third historical distance and the estimate current distance may be 0.1. The current distance between the aerial vehicle and the reference object may be calculated to be: ( 3*0.7+5*0.3+7*0.1)/(0.7+0.3+0.1)=3.91 m.

In some embodiments, when the aerial vehicle is first initialized, the most recent obtained distance between the aerial vehicle and the reference object may not be available. The aerial vehicle may use the average of the historical distances between the aerial vehicle and the reference object obtained in the previous n times as the most recent obtained distance between the aerial vehicle and the reference object, where n may be a positive integer.

In the embodiment of the present disclosure, when the aerial vehicle flies near the reference object, the obtained observation value may be on the left side of the observation value corresponding to the maximum confidence probability of the preset bilateral filtering function, the slope may be relatively flat, and the obtain filtering result may be similar to the distance between the aerial vehicle and the reference object. Further, when the aerial vehicle is far away from the reference object, the obtained observation value may be on the right side of the observation value corresponding to the maximum confidence probability of the preset bilateral filtering function, the confidence probability may drop sharply, and the obtain filtering result may be similar to the distance between the aerial vehicle and the reference object.

Step S304, obtaining the flight speed corresponding to the current distance based on the pre-established correspondence between the distance between the aerial vehicle and the reference object and the flight speed.

In the conventional flight control method, when the aerial vehicle is passing through the window or the door frame, due to the limit of the FOV of the second camera, the two sides of the window or the door frame may not be detected. The aerial vehicle may mistakenly believe there is no obstacle and increase the flight speed sharply, which may decrease the safely of the aerial vehicle. In the embodiment of the present disclosure, the aerial vehicle may calculate the historical distances between the aerial vehicle and the reference object obtained during the predetermined time period, and process the historical distances through the preset bilateral filter to obtain the current distance between the aerial vehicle and the reference object. The aerial vehicle may further obtain the flight speed corresponding to the current distance based on the pre-established correspondence between the distance between the aerial vehicle and the reference object and the flight speed, and control the aerial vehicle to fly based on the current speed to avoid sudden increase of the flight speed, thereby increasing the safety of the aerial vehicle during flight.

Step S305, controlling the aerial vehicle to fly based on the flight speed.

In some embodiments, the aerial vehicle may establish a communication connection with a control device, and receive a shutdown command for the obstacle avoidance mode transmitted by the control device through the communication connection with the control device. In particular, the shutdown command may be generated when the control device detects a user's click operation on a preset button in the control device, and the obstacle avoidance mode may be turned off in response to the shutdown command. More specifically, turning off the obstacle avoidance mode may include: the aerial vehicle stops processing the historical distances through the preset bilateral filter, obtains the current distance between the aerial vehicle and the reference object, and stops controlling aerial vehicle to fly based on the obtained flight speed. In one embodiment, when the second image acquired by the aerial vehicle by the second camera based on the reduced FOV of the second camera includes the reference object, the aerial vehicle may determine that the size of the window or the door frame is small, and the aerial vehicle cannot pass through the window or the door frame. If the user determines that the aerial vehicle may smoothly pass through the window or the door frame based on experience, the user may click the button in the control device designate to turn off the obstacle avoidance mode. After the control device receives the shutdown command for the obstacle avoidance mode, the control device may transmit the shutdown command for the obstacle avoidance mode to the aerial vehicle through the communication connection, and the aerial vehicle may turn off the obstacle avoidance mode in response to the shutdown command.

In some embodiments, the aerial vehicle may generate the shutdown command for the obstacle avoidance mode in response to detecting the aerial vehicle is in the shuttle mode, and the obstacle avoidance mode may be turned off in response to the shutdown command.

In the flight control method shown in FIG. 3, the aerial vehicle may identify the reference object in the flight environment in which the aerial vehicle may be located, calculate the historical distances between the aerial vehicle and the reference object obtained in the predetermined time period, process the historical distances by using the preset bilateral filter to obtain the current distance between the aerial vehicle and the reference object based on the pre-established correspondence between the distance between the aerial vehicle and the reference object and the flight speed, and control the aerial vehicle to fly based on the flight speed to effectively achieve obstacle avoidance.

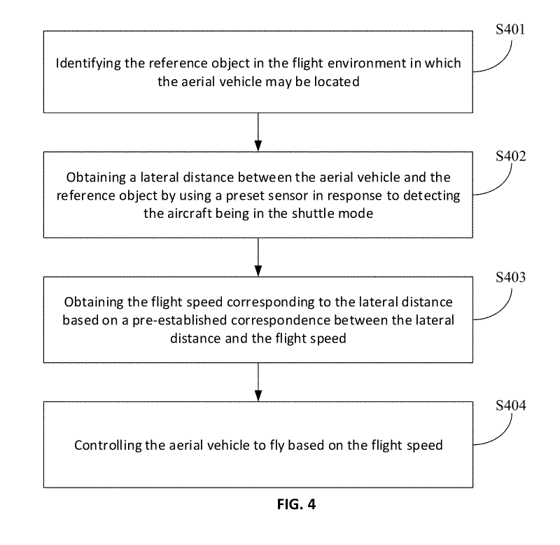

Another embodiment of the present disclosure further provides a flight control method. For example, the flight control method may be applied to the scenarios of passing through a narrow space. Referring to FIG. 4, which is a schematic flowchart of a flight control method according to another embodiment of the present disclosure. As shown in FIG. 4, the flight control method in the present embodiment may include at least the following steps:

Step S401, identifying the reference object in the flight environment in which the aerial vehicle may be located.

In one embodiment, when the aerial vehicle is passing through a narrow space, the reference object in the flight environment in which the aerial vehicle may be located may be identified, where the reference object may include a forest, a group of buildings, or the like.

Step S402, obtaining a lateral distance between the aerial vehicle and the reference object by using a preset sensor in response to detecting the aerial vehicle being in the shuttle mode.

In some embodiments, before the aerial vehicle determines the lateral distance between the aerial vehicle and the reference object by using the preset sensor, it can be determined that the aerial vehicle may be in the obstacle avoidance mode.

In particular, the preset sensor may include an ultrasonic transmitter, a laser emitter, a radar, or the like.

Step S403, obtaining the flight speed corresponding tot eh lateral distance based on a pre-established correspondence between the lateral distance and the flight speed.

In one embodiment, the aerial vehicle may pre-establish the correspondence between the lateral distance between the aerial vehicle and the reference object and the flight speed. For example, the lateral distance between the aerial vehicle and the reference object and the flight speed may be proportional to each other. In one example, when the lateral distance between the aerial vehicle and the reference object is 2 m, the corresponding flight speed may be 2 m/s; when the lateral distance between the aerial vehicle and the reference object is 5 m, the corresponding flight speed may be 5 m/s. Further, the flight speed corresponding to the lateral distance may be obtained based on the pre-established correspondence between the lateral distance and the flight speed. In addition, the aerial vehicle may also set a maximum flight speed of 10 m/s to avoid the case of the aerial vehicle flying too fast through a narrow space with reference object with relatively small lateral distance in front of it, so the aerial vehicle may not be able to decelerate in time, thereby improving the safety of the aerial vehicle during flight.

Step S404, controlling the aerial vehicle to fly based on the flight speed.

In some embodiments, the aerial vehicle may establish a communication connection with a control device, and receive a shutdown command for the obstacle avoidance mode sent by the control device through the communication connection with the control device. In particular, the shutdown command may be generated when the control device detects a user's click operation on a preset button in the control device, and the obstacle avoidance mode may be turned off in response to the shutdown command. More specifically, turning off the obstacle avoidance mode may include: the aerial vehicle stops obtaining the lateral distance between the aerial vehicle and the reference object through the preset sensor and stops controlling the aerial vehicle to fly based on the obtained flight speed. In one embodiment, when the aerial vehicle obtains a large lateral distance between the aerial vehicle and the reference object through the preset sensor, and there is a reference object with a small lateral distance in front of it, the user may want the aerial vehicle to decelerate immediately to ensure the safety of the aerial vehicle. In this case, the user may click the button in the control device designate to turn off the obstacle avoidance mode. After the control device receives the shutdown command for the obstacle avoidance mode, the control device may transmit the shutdown command for the obstacle avoidance mode to the aerial vehicle through the communication connection, and the aerial vehicle may turn off the obstacle avoidance mode in response to the shutdown command.

In some embodiments, the aerial vehicle may generate the shutdown command for the obstacle avoidance mode in response to detecting the aerial vehicle is in the shuttle mode, and the obstacle avoidance mode may be turned off in response to the shutdown command.

In the flight control method shown in FIG. 4, the aerial vehicle may identify the reference object in the flight environment in which the aerial vehicle may be located, obtain the lateral distance between the aerial vehicle and the reference object by using the preset sensor in response to detecting the aerial vehicle being in the shuttle mode, obtain the flight speed corresponding to the lateral distance based on the pre-established correspondence between the lateral distance and the flight speed, and control the aerial vehicle to fly based on the flight speed to effectively achieve obstacle avoidance.

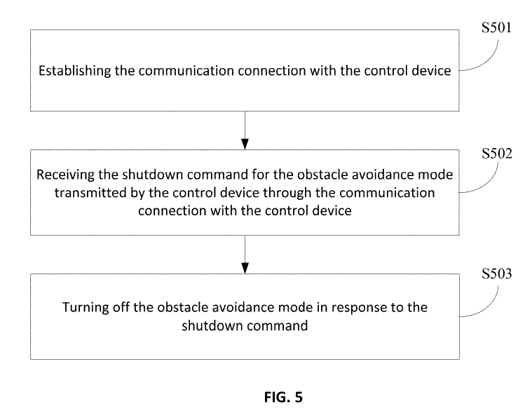

Another embodiment of the present disclosure further provides a flight control method. Referring to FIG. 5, which is a schematic flowchart of a flight control method according to another embodiment of the present disclosure. As shown in FIG. 5, the flight control method in the present embodiment may include at least the following steps:

Step S501, establishing a communication connection with a control device.

In one embodiment, the aerial vehicle may establish the communication connection with the control device via a ground station, a 2.4 GHz radio, etc.

Step S502, receiving a shutdown command for an obstacle avoidance mode transmitted by the control device through the communication connection with the control device.

In one embodiment, the control device may detect that a user has clicked on a preset button in the control device to generate the shutdown command for the obstacle avoidance mode and transmit the shutdown command to the aerial vehicle through the communication connection with the aerial vehicle. For example, when the aerial vehicle acquires that the flight speed of the aerial vehicle relative to the ground is relatively slow by analyzing the first image and the user wants to maintain the flight speed of the aerial vehicle, the user may click a button on the control device designated to turn off the obstacle avoidance mode. After the control device receives the shutdown command for the obstacle avoidance mode, the shutdown command may be transmitted to the aerial vehicle through the communication connection, and the aerial vehicle may turn off the obstacle avoidance mode in response to the shutdown command.

In another example, when the second image acquired by the aerial vehicle by the second camera based on the reduced FOV of the second camera includes the reference object, the aerial vehicle may determine that the size of the window or the door frame is small, and the aerial vehicle cannot pass through the window or the door frame. If the user determines that the aerial vehicle may smoothly pass through the window or the door frame based on experience, the user may click the button in the control device designate to turn off the obstacle avoidance mode. After the control device receives the shutdown command for the obstacle avoidance mode, the control device may transmit the shutdown command for the obstacle avoidance mode to the aerial vehicle through the communication connection, and the aerial vehicle may turn off the obstacle avoidance mode in response to the shutdown command.

In another example, when the aerial vehicle obtains a large lateral distance between the aerial vehicle and the reference object through the preset sensor, and there is a reference object with a small lateral distance in front of it, the user may want the aerial vehicle to decelerate immediately to ensure the safety of the aerial vehicle. In this case, the user may click the button in the control device designate to turn off the obstacle avoidance mode. After the control device receives the shutdown command for the obstacle avoidance mode, the control device may transmit the shutdown command for the obstacle avoidance mode to the aerial vehicle through the communication connection, and the aerial vehicle may turn off the obstacle avoidance mode in response to the shutdown command.

Step S503, turning off the obstacle avoidance mode in response to the shutdown command.

In some embodiments, the aerial vehicle may generate the shutdown command for the obstacle avoidance mode in response to detecting the aerial vehicle is in the shuttle mode, and the obstacle avoidance mode may be turned off in response to the shutdown command.

In the flight control method shown in FIG. 5, the aerial vehicle may establish the communication connection with the control device, receive the shutdown command for the obstacle avoidance mode transmitted by the control device through the communication connection with the control device, and turn off the obstacle avoidance mode in response to the shutdown command, so it may be possible to determine whether to turn off the obstacle avoidance mode based on different application scenarios with a convenient operation.

An embodiment of the present disclosure further provides a computer storage medium, where the computer storage medium may store computer executable instructions, and the computer executable instructions may include some or all of the steps in the method embodiments shown in FIG. 1 to FIG. 5 when executed.

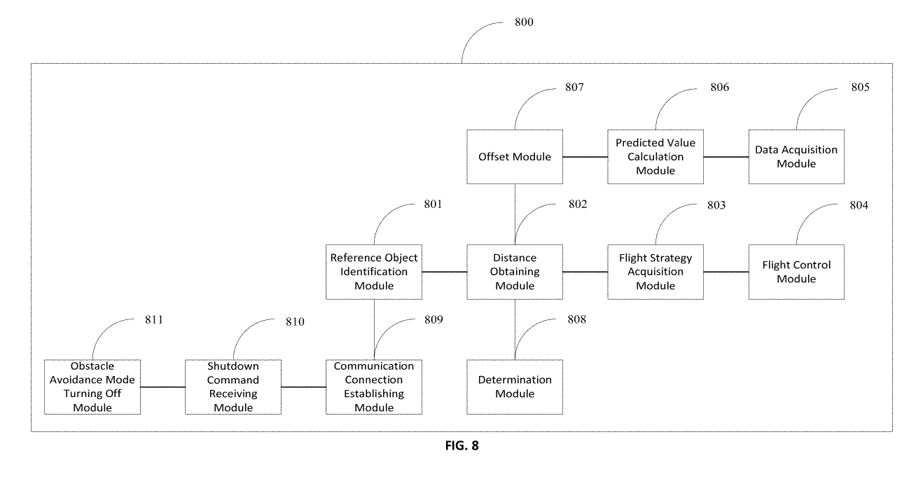

Referring to FIG. 8, which is a schematic structural diagram of a flight control apparatus 800 according to an embodiment of the present disclosure. The flight control apparatus 800 may be used to implement some or all of the steps in the method embodiments shown in FIG. 1 to FIG. 4. The flight control apparatus 800 may include at least a reference object identification module 801, a distance obtaining module 802, a flight strategy acquisition module 803, and a flight control module 804, where:

The reference object identification module 801 may be used to identify reference object in the flight environment in which the aerial vehicle is located.

The distance obtaining module 802 may be used to obtain the distance between the aerial vehicle and the reference object.

The flight strategy acquisition module 803 may be used to acquire the flight strategy corresponding to the distance based on the pre-established correspondence between the distance between the aerial vehicle and the reference object and the flight strategy.

The flight control module 804 may be used to control the aerial vehicle to fly based on the flight strategy.

In some embodiments, the distance obtaining module 802 may be used to: acquire the first image through the first camera, where the first image may include the ground; and analyze the first image to obtain the flight height of the aerial vehicle relative to the ground.

Further, a flight speed acquisition module 603 may be used to acquire the flight speed corresponding to the flight height based on the pre-established correspondence between the flight height and the flight speed.

In some embodiments, the distance obtaining module 802 may analyze the first image to obtain the flight height of the aerial vehicle relative to the ground. More specifically, the distance obtaining module 802 may determine the reference line of the ground and its end line; obtain the distance between the reference line and the end line; obtain the flight height corresponding to the distance based on the pre-established correspondence between the distance between the reference line and the end line and the flight height; and use the flight height corresponding to the distance as the flight height of the aerial vehicle relative to the ground.

In some embodiments, the first camera may be located directly below the aerial vehicle, and the distance obtaining module 802 may analyze the first image to obtain the flight height of the aerial vehicle relative to the ground. More specifically, the obtaining module 802 may acquire the flight position of the aerial vehicle by using the preset position sensor; and analyze the first image based on the flight position of the aerial vehicle to calculate the flight height of the aerial vehicle relative to the ground.

In some embodiments, the flight control module 804 may be specifically used to: reduce the viewing angle of the FOV of the second camera in the aerial vehicle in response to the distance between the aerial vehicle and the reference object being within the predetermined distance range such that the reduced FOV of the second camera may match the size of the aerial vehicle; acquire the second image by using the second camera based on the reduced FOV of the second camera; control the aerial vehicle to stop flying in response to the second image including the reference object; and control the aerial vehicle to remain in flight in response to the second image not including the reference object.

In some embodiments, the flight control module 804 may reduce the FOV of the second camera in the aerial vehicle. More specifically, the flight control module 804 may acquire the FOV corresponding to the distance based on the pre-established correspondence between the distance between the aerial vehicle and the reference object and the FOV; and update the FOV of the second camera such that the updated FOV may be the same as the acquired FOV.

In some embodiments, the distance obtaining module 802 may be specifically used to calculate the historical distances between the aerial vehicle and the reference object obtained in the predetermined time period; and obtain the current distance between the aerial vehicle and the reference object by processing the historical distances using the preset bilateral filter.

Further, the flight strategy acquisition module 803 may be specifically used to obtain the flight speed corresponding to the current distance based on the pre-established correspondence between the distance between the aerial vehicle and the reference object and the flight speed.

In some embodiments, the flight control apparatus 800 may further include:

A data acquisition module 805, which may be used to obtain the historical filtering result and the current velocity vector of the aerial vehicle before the distance obtaining module 802 processes the historical distances by using the preset bilateral filter to obtain the current distance between the aerial vehicle and the reference object.

A predicted value calculation module 806, which may be used to calculate the predicted values based on the historical filtering results and the velocity vectors.

An offset module 807, which may be used to perform the offset in the preset bilateral filtering function, where the confidence probability corresponding to the predicted values in the offset preset bilateral filtering function may be the maximum confidence probability.

In some embodiments, the distance obtaining module 802 may process the historical distances by using the preset bilateral filter to obtain the current distance between the aerial vehicle and the reference object. More specifically, the distance obtaining module 802 may obtain the expected values between each of historical distances and the predicted values; obtain the confidence probabilities corresponding to each of the expected values based on the offset preset bilateral filtering function; and obtain the current distance between the aerial vehicle and the reference object by normalizing the confidence probabilities corresponding to each of the expected values.

In some embodiments, the distance obtaining module 802 may be specifically used to obtain the lateral distance between the aerial vehicle and the reference object by using the preset position sensor in response to detecting the aerial vehicle being in the shuttle mode.

In some embodiments, the flight strategy acquisition module 803 may be specifically used to obtain the flight speed corresponding to the lateral distance based on the pre-established correspondence between the lateral distance between the aerial vehicle and the reference object and the flight speed.

In some embodiments, the flight control apparatus 800 may further include:

A determination module 808, which may be used to determine whether the aerial vehicle may be in the obstacle avoidance mode before the distance obtaining module 802 obtains the distance between the aerial vehicle and the reference object.

In some embodiments, the flight control apparatus 800 may further include:

A communication connection establishing module 809, which may be used to establish the communication connection with the control device.

A shutdown command receiving module 810, which may be used to receive the shutdown command for the obstacle avoidance mode transmitted by the control device through the communication connection, where the shutdown command may be generated when the control device detects the clicking operation of the preset button by the user.

An obstacle avoidance mode turning off module 811, which may be used to turn off the obstacle avoidance mode in response to the shutdown command.

In addition, the shutdown command receiving module 810 may be used to generate the shutdown command for the obstacle avoidance mode in response to detecting the aerial vehicle being in the shuttle mode; and the obstacle avoidance mode turning off module 811 may be used to turn off the obstacle avoidance mode in response to the shutdown command.

In the flight control apparatus 800 shown in FIG. 8, the reference object identification module 801 may identify reference object in the flight environment in which the aerial vehicle may be located, the distance obtaining module 802 may obtain the distance between the aerial vehicle and the reference object, and the flight strategy acquisition module 803 may acquire the flight strategy corresponding to the distance based on the pre-established correspondence between the distance and the flight strategy, and the flight control module 804 may control the aerial vehicle to fly based on the flight strategy, which may effectively achieve obstacle avoidance.

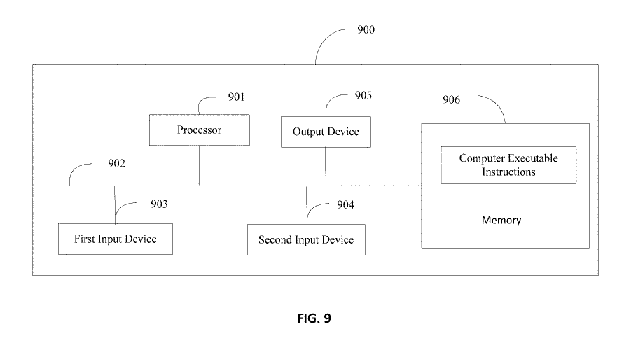

Referring to FIG. 9, which is a schematic structural diagram of an aerial vehicle 900 according to an embodiment of the present disclosure. The aerial vehicle 900 provided in the embodiment of the present disclosure may be used to implement embodiments of the flight control methods shown in FIG. 1 to FIG. 4 above. For the convenience of description, only the parts related to the present embodiment of the present disclosure are shown, and the specific technical details not disclosed may refer to the embodiments of the present disclosure shown in FIG. 1 to FIG. 4.

As shown in FIG. 9, the aerial vehicle 900 may include: one or more processors 701 such as a CPU; one or more first input devices 903; one or more second input devices 904; one or more output devices 905; a memory 906; and one or more communication buses 902. In particular, the communication buses 902 may be used to establish the communication connection between these components; and the first input device may be the first camera, which may be specifically used to acquire the first image. The second input device 904 may also be the second camera, which may be used to acquire the second image. The output device 905 may be a display, which may be specifically used to display images or the like. The memory 906 may include high speed RAM memory and may also include non-volatile memory, such as one or more disk memory. Further, the memory 906 may optionally include one or more storage devices located remotely from the aforementioned processors 901. In addition, the memory may store computer executable instructions and the processors 901 may execute the computer executable instructions stored in the memory 906 to identify the reference object in the flight environment in which the aerial vehicle is located; obtain the distance between the aerial vehicle and the reference object; acquire the flight strategy corresponding to the distance based on the pre-established correspondence between the distance and the flight strategy; and control the aerial vehicle to fly based on the flight strategy.

In some embodiments, the processors 901 may acquire the distance between the aerial vehicle and the reference object. More specifically, the processors 901 may acquire the first image through the first input device 903, where the first image may include the ground; and analyze the first image to obtain the flight height of the aerial vehicle relative to the ground.

Further, the processors 901 may acquire the flight strategy corresponding to the distance based on the pre-established correspondence between the distance and the flight strategy. More specifically, the processors 901 may acquire the flight speed corresponding to the flight height based on the pre-established correspondence between the flight height and the flight speed.

In some embodiments, the processors 901 may analyze the first image to obtain the flight height of the aerial vehicle relative to the ground. More specifically, the processors 901 may determine the reference line of the ground and its end line; obtain the distance between the reference line and the end line; obtain the flight height corresponding to the distance based on the pre-established correspondence between the distance between the reference line and the end line and the flight height; and use the flight height corresponding to the distance as the flight height of the aerial vehicle relative to the ground.

In some embodiments, the first camera may be located directly below the aerial vehicle, and the processors 901 may analyze the first image to obtain the flight height of the aerial vehicle relative to the ground. More specifically, the processors 901 may acquire the flight position of the aerial vehicle by using the preset position sensor; and analyze the first image based on the flight position of the aerial vehicle to calculate the flight height of the aerial vehicle relative to the ground.

In some embodiments, the processors 901 may control the aerial vehicle to fly based on the flight strategy. More specifically, the processors 901 may reduce the viewing angle of the FOV of the second input device 904 in the aerial vehicle in response to the distance between the aerial vehicle and the reference object being within the predetermined distance range such that the reduced FOV of the second input device 904 may match the size of the aerial vehicle; acquire the second image by using the second input device 904 based on the reduced FOV of the second camera; control the aerial vehicle to stop flying in response to the second image including the reference object; and control the aerial vehicle to remain in flight in response to the second image not including the reference object.

In some embodiments, the processors 901 may reduce the FOV of the second input device 904 in the aerial vehicle. More specifically, the processors 901 may acquire the FOV corresponding to the distance based on the pre-established correspondence between the distance between the aerial vehicle and the reference object and the FOV; and update the FOV of the second input device 904 such that the updated FOV may be the same as the acquired FOV.

In some embodiments, the processors 901 may obtain the distance between the aerial vehicle and the reference object. More specifically, the processors 901 may calculate the historical distances between the aerial vehicle and the reference object obtained in the predetermined time period; and obtain the current distance between the aerial vehicle and the reference object by processing the historical distances using the preset bilateral filter.

Further, the processors 901 may obtain the flight speed corresponding to the distance based on the pre-established correspondence between the distance and the flight speed. More specifically the processors 901 may obtain the flight speed corresponding to the current distance based on the pre-established correspondence between the distance and the flight speed.

In some embodiments, before the processors 901 processes the historical distances using the preset bilateral filter to obtain the current distance between the aerial vehicle and the reference object, the processors 901 may obtain the historical filtering result and the current velocity vector of the aerial vehicle; calculate the predicted values based on the historical filtering results and the velocity vectors; and perform the offset in the preset bilateral filtering function, where the confidence probability corresponding to the predicted values in the offset preset bilateral filtering function may be the maximum confidence probability.

In some embodiments, the processor may process the historical distances by using the preset bilateral filter to obtain the current distance between the aerial vehicle and the reference object. More specifically, the processors 901 may obtain the expected values between each of historical distances and the predicted values; obtain the confidence probabilities corresponding to each of the expected values based on the offset preset bilateral filtering function; and obtain the current distance between the aerial vehicle and the reference object by normalizing the confidence probabilities corresponding to each of the expected values.

In some embodiments, the processors 901 may obtain the distance between the aerial vehicle and the reference object, which may include obtaining the lateral distance between the aerial vehicle and the reference object by using the preset position sensor in response to detecting the aerial vehicle being in the shuttle mode.

Further, the processors 901 may acquire the flight strategy corresponding to the distance based on the pre-established correspondence between the distance between the aerial vehicle and the reference object and the flight strategy, which may include obtaining the flight speed corresponding to the lateral distance based on the pre-established correspondence between the lateral distance between the aerial vehicle and the reference object and the flight speed.

In some embodiments, before the processors 901 obtains the distance between the aerial vehicle and the reference object, the processors 901 may determine whether the aerial vehicle may be in the obstacle avoidance mode.

In some embodiments, the processors 901 may be further used to establish the communication connection with the control device; receive the shutdown command for the obstacle avoidance mode transmitted by the control device through the communication connection, where the shutdown command may be generated when the control device detects the clicking operation of the preset button by the user; and turn off the obstacle avoidance mode in response to the shutdown command.

In addition, the processors 901 may be further used to generate the shutdown command for the obstacle avoidance mode in response to detecting the aerial vehicle being in the shuttle mode; and turn off the obstacle avoidance mode in response to the shutdown command.

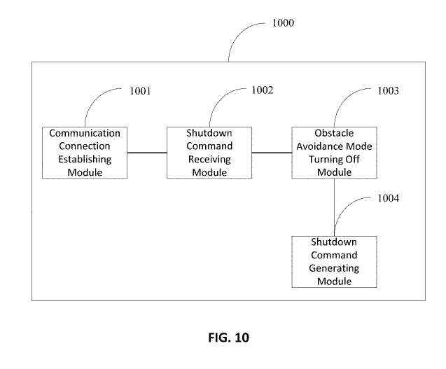

Referring to FIG. 10, which is a schematic structural diagram of a flight control apparatus 1000 according to another embodiment of the present disclosure. The flight control apparatus 1000 may be used to implement some or all of the steps in the flight control method shown in FIG. 5. The flight control apparatus 1000 may include at least a communication connection establishing module 1001, a shutdown command receiving module 1002, and an obstacle avoidance mode turning off module 1003. In particular:

The communication connection establishing module 1001 may be used to establish the communication connection with the control device.

The shutdown command receiving module 1002 may be used to receive the shutdown command for the obstacle avoidance mode transmitted by the control device through the communication connection, where the shutdown command may be generated when the control device detects the clicking operation of the preset button by the user.

The obstacle avoidance mode turning off module 1003 may be used to turn off the obstacle avoidance mode in response to the shutdown command.

In some embodiments, the flight control apparatus 1000 may further include:

A shutdown command generating module 1004, which may be used to generate the shutdown command for the obstacle avoidance mode in response to detecting the aerial vehicle being in the shuttle mode.

Further, the obstacle avoidance mode turning off module 1003 may be used to turn off the obstacle avoidance mode in response to the shutdown command.

In the flight control apparatus 1000 shown in FIG. 10, the communication connection establishing module 1001 may establish the communication connection with the control device, the shutdown command receiving module 1002 may receive the shutdown command for the obstacle avoidance mode transmitted by the control device through the communication connection with the control device, and the obstacle avoidance mode turning off module 1003 may turn off the obstacle avoidance mode in response to the shutdown command, so it may be possible to determine whether to turn off the obstacle avoidance mode based on different application scenarios with a convenient operation.

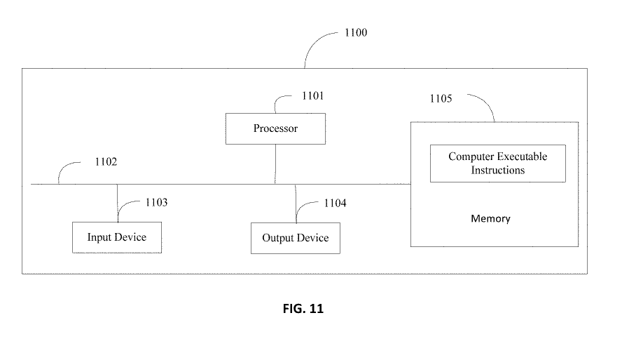

Referring to FIG. 11, which is a schematic structural diagram of an aerial vehicle 1100 according to another embodiment of the present disclosure. The aerial vehicle 1100 provided in the embodiment of the present disclosure may be used to implement embodiments of the flight control method shown in FIG. 5 above. For the convenience of description, only the parts related to the present embodiment of the present disclosure are shown, and the specific technical details not disclosed may refer to the embodiments of the present disclosure shown in FIG. 5.

As shown in FIG. 11, the aerial vehicle 1100 may include

As shown in FIG. 11, the aerial vehicle 1100 may include: one or more processors 1101 such as a CPU; one or more input devices 1103; one or more output devices 1104; a memory 1105; and one or more communication buses 1102. In particular, the communication buses 1102 may be used to establish the communication connection between these components; and the input devices may be network ports or the like. The output devices 1104 may be network ports or the like. The memory 1105 may include high speed RAM memory and may also include non-volatile memory, such as one or more disk memory. Further, the memory 1105 may optionally include one or more storage devices located remotely from the aforementioned processors 1101. In addition, the memory 1105 may store computer executable instructions and the processors 1101 may execute the computer executable instructions stored in the memory 1105 to establish the communication connection with the control device.

The input devices 1103 may receive the shutdown command for the obstacle avoidance mode transmitted by the control device through the communication connection, where the shutdown command may be generated when the control device detects the clicking operation of the preset button by the user; and turn off the obstacle avoidance mode in response to the shutdown command.

In addition, the processors 1101 may be further used to generate the shutdown command for the obstacle avoidance mode in response to detecting the aerial vehicle being in the shuttle mode; and turn off the obstacle avoidance mode in response to the shutdown command.

In the description of the present invention are novel, reference to the term “one embodiment,” “some embodiments”, “an example”, “a specific example”, or “some examples” means that a description of the embodiment or exemplary embodiments the particular features, structures, materials, or characteristics in the present invention comprise at least one embodiment or exemplary embodiments. In the present specification, a schematic representation of the above terms must not be the same for the embodiment or exemplary embodiments. Furthermore, the particular features, structures, materials, or characteristics described may be in any one or more embodiments or examples combined in suitable manner. Furthermore, different embodiments or examples and embodiments or features of different exemplary embodiments without conflicting, those skilled in the art described in this specification can be combined and the combination thereof.

It should be noted that, in the description of the present disclosure, terms such as “first” and “second” are used herein for purposes of description and are not intended to indicate or imply relative importance or significance. Furthermore, in the description of the present disclosure, “a plurality of” refers to two or more unless otherwise specified.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the functions may be executed in other orders instead of the order illustrated or discussed, including in a basically simultaneous manner or in a reverse order, which should be understood by those skilled in the art.

The logic and/or steps described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A flight control method used in an aerial vehicle, comprising:
identifying a reference object in a flight environment;
obtaining a distance between the aerial vehicle and the reference object;
acquiring a flight strategy corresponding to the distance based on a correspondence between the distance between the aerial vehicle and the reference object and the flight strategy; and,
controlling the aerial vehicle to fly based on the flight strategy.

2. The flight control method of claim 1, wherein obtaining the distance between the aerial vehicle and the reference object includes:
acquiring a first image through a first camera, the first image including a ground;
analyzing the first image to obtain a flight height of the aerial vehicle relative to the ground;
acquiring the flight strategy corresponding to the distance based on a correspondence between the distance between the aerial vehicle and the reference object and the flight strategy; and
obtaining a flight speed corresponding to the flight height based on a correspondence between the flight speed and the flight height of the aerial vehicle relative to the ground.

3. The flight control method of claim 2, wherein analyzing the first image to obtain the flight height of the aerial vehicle relative to the ground includes:
determining a reference line of the ground and its end line in the first image;
obtaining a distance between the reference line and the end line;
obtaining the flight height corresponding to the distance based on a correspondence between the distance between the reference line and the end line and the flight height; and,
using the flight height corresponding to the distance as the flight height of the aerial vehicle relative to the ground.

4. The flight control method of claim 2, wherein the first camera is located directly below the aerial vehicle and analyzing the first image to obtain the flight height of the aerial vehicle relative to the ground includes:
obtaining a flight position by using a position sensor;
analyzing the first image based on the flight position of the aerial vehicle to calculate the flight height of the aerial vehicle relative to the ground.

5. The flight control method of claim 1, wherein controlling the aerial vehicle to fly based on the fly strategy includes:
reducing a FOV of a second camera in the aerial vehicle in response to the distance between the aerial vehicle and the reference object being within a distance range such that the FOV of the reduced second camera matches the size of the aerial vehicle;
acquiring a second image using the second camera based on the reduced FOV of the second camera;
controlling the aerial vehicle to stop flying in response to the second image including the reference objects; and,
controlling the aerial vehicle to remain in flight in response to the second image not including the reference objects.

6. The flight control method of claim 5, wherein reducing the FOV of the second camera in the aerial vehicle includes:
acquiring the FOV corresponding to the distance based on a correspondence between the distance between the aerial vehicle and the reference object and the FOV; and,
updating the FOV of the second camera to be the same as the acquired FOV.

7. The flight control method of claim 1, wherein obtaining the distance between the aerial vehicle and the reference object includes:
calculating a plurality of historical distances between the aerial vehicle and the reference object obtained during a time period;
processing the historical distances by using a bilateral filter to obtain a current distance between the aerial vehicle and the reference object;
obtaining the flight strategy corresponding to the distance based on the correspondence between the distance between the aerial vehicle and the reference object and the flight strategy; and
obtaining the flight speed corresponding to the current distance based on the correspondence between the flight speed and the distance between the aerial vehicle and the reference object.

8. The flight control method of claim 7, wherein before processing the historical distances by using the preset bilateral filter to obtain the current distance between the aerial vehicle and the reference object further includes:
obtaining a historical filtering result and a current velocity vector of the aerial vehicle;
calculating a predicted value based on the historical filtering results and the velocity vector; and,
offsetting a bilateral filtering function, a confidence probability corresponding to the predicted value in the offset bilateral filtering function is the maximum confidence probability.

9. The flight control method of claim 8, wherein processing the historical distances by using the bilateral filter to obtain the current distance between the aerial vehicle and the reference object further includes:
obtaining an expected value between each historical distance and the predicted value;
obtaining the confidence probability corresponding to each expected value based on the offset bilateral filtering function; and,
normalizing the confidence probability corresponding to each expected value to obtain the current distance between the aerial vehicle and the reference object.

10. The flight control method of claim 1, wherein obtaining the distance between the aerial vehicle and the reference object includes:
obtaining a lateral distance between the aerial vehicle and the reference object by using the position sensor in response to detecting the aerial vehicle being in a shuttle mode;
acquiring the flight strategy corresponding to the distance based on the correspondence between the distance between the aerial vehicle and the reference object and the flight strategy; and
obtaining the flight speed corresponding to the lateral distance based on a correspondence between the flight speed and the lateral distance between the aerial vehicle and the reference object.

11. The flight control method of claim 1, further comprising:
determining whether the aerial vehicle is in an obstacle avoidance mode.

12. The flight control method of claim 1, further comprising:
establishing a communication connection with a control device;
receiving a shutdown command for the obstacle avoidance mode transmitted by the control device through the communication connection with the control device, the shutdown command being generated when the control device detecting a clicking operation of a button; and,
switching off the obstacle avoidance mode in response to the shutdown command.

13. The flight control method of claim 1, further comprising:
generating the shutdown command for the obstacle avoidance mode in response to detecting the aerial vehicle being in the shuttle mode; and,
switching off the obstacle avoidance mode in response to the shutdown command.

14. A flight control method of used in an aerial vehicle, comprising:
establishing a communication connection with a control device;
receiving a shutdown command for the obstacle avoidance mode transmitted by the control device through the communication connection with the control device, the shutdown command being generated when the control device detects a clicking operation of a button by a user; and
switching off the obstacle avoidance mode in response to the shutdown command.

15. The flight control method of claim 14, further comprising:
generating the shutdown command for the obstacle avoidance mode in response to detecting the aerial vehicle being in the shuttle mode; and, switching off the obstacle avoidance mode in response to the shutdown command.

16. An aerial vehicle including a first input device, a second input device, an output device, a memory for storing computer executable instructions, and a processor to execute the computer executable instructions stored in the memory to perform:
identifying a reference object in a flight environment;
obtaining a distance between the aerial vehicle and the reference object;
acquiring a flight strategy corresponding to the distance based on a correspondence between the aerial vehicle and the reference object and the flight strategy;
controlling the aerial vehicle to fly based on the flight strategy.

17. The aerial vehicle of claim 16, wherein the processor obtains the distance between the aerial vehicle and the reference object includes:
acquiring a first image through the first input device, the first image includes a ground;
analyzing the first image to obtain a flight height of the aerial vehicle relative to the ground;
acquiring the flight strategy corresponding to the distance based on a correspondence between the distance between the aerial vehicle and the reference object and the flight strategy; and
obtaining a flight speed corresponding to the flight height based on a correspondence between the flight speed and the flight height of the aerial vehicle relative to the ground.

18. The aerial vehicle of claim 17, wherein the processor analyzes the first image to obtain the flight height of the aerial vehicle relative to the ground includes:
determining a reference line of the ground and its end line in the first image;
obtaining a distance between the reference line and the end line;
obtaining the flight height corresponding to the distance based on a correspondence between the distance between the reference line and the end line and the flight height; and,
using the flight height corresponding to the distance as the flight height of the aerial vehicle relative to the ground.

19. The aerial vehicle of claim 17, wherein the first input device is located directly below the aerial vehicle and the processor analyzes the first image to obtain the flight height of the aerial vehicle relative to the ground includes:
obtaining a flight position by using a position sensor;
analyzing the first image based on the flight position of the aerial vehicle to calculate the flight height of the aerial vehicle relative to the ground.

20. The aerial vehicle of claim 16, wherein the processor controls the aerial vehicle to fly based on the fly strategy includes:
reducing a FOV of a second input device in the aerial vehicle in response to the distance between the aerial vehicle and the reference object being within a distance range such that the FOV of the reduced second input device matches the size of the aerial vehicle;
acquiring a second image using the second input device based on the reduced FOV of the second input device;
controlling the aerial vehicle to stop flying in response to the second image including the reference objects; and,
controlling the aerial vehicle to remain in flight in response to the second image not including the reference objects.

21. The aerial vehicle of claim 20, wherein the processor reduces the FOV of the second input device in the aerial vehicle includes:
acquiring the FOV corresponding to the distance based on a correspondence between the distance between the aerial vehicle and the reference object and the FOV; and,
updating the FOV of the second input device to be the same as the acquired FOV.

22. The aerial vehicle of claim 16, wherein the processor obtains the distance between the aerial vehicle and the reference object includes:
calculating a plurality of historical distances between the aerial vehicle and the reference object obtained during a time period;
processing the historical distances by using a bilateral filter to obtain a current distance between the aerial vehicle and the reference object;
obtaining the flight strategy corresponding to the distance based on the correspondence between the distance between the aerial vehicle and the reference object and the flight strategy; and
obtaining the flight speed corresponding to the current distance based on the correspondence between the flight speed and the distance between the aerial vehicle and the reference object.

23. The aerial vehicle of claim 22, the processor further performing:
obtaining a historical filtering result and a current velocity vector of the aerial vehicle;
calculating a predicted value based on the historical filtering results and the velocity vector; and,
offsetting a bilateral filtering function, a confidence probability corresponding to the predicted value in the offset bilateral filtering function being the maximum confidence probability.

24. The aerial vehicle of claim 23, wherein the processor further performing:
obtaining an expected value between each historical distance and the predicted value;
obtaining the confidence probability corresponding to each expected value based on the offset bilateral filtering function; and,
normalizing the confidence probability corresponding to each expected value to obtain the current distance between the aerial vehicle and the reference object.

25. The aerial vehicle of claim 16, wherein the processor further performing:
obtaining a lateral distance between the aerial vehicle and the reference object by using the position sensor in response to detecting the aerial vehicle being in a shuttle mode;
acquiring the flight strategy corresponding to the distance based on the correspondence between the distance between the aerial vehicle and the reference object; and
obtaining the flight speed corresponding to the lateral distance based on a correspondence between the flight speed and the lateral distance between the aerial vehicle and the reference object.

26. The aerial vehicle of claim 16, wherein before the processor obtains the distance between the aircraft and the reference object further includes:
determining whether the aerial vehicle is in an obstacle avoidance mode.

27. The aerial vehicle of claim 16, the processor further performing:
establishing a communication connection with a control device;
receiving a shutdown command for the obstacle avoidance mode transmitted by the control device through the communication connection with the control device, the shutdown command being generated when the control device detects a clicking operation of a button; and
switching off the obstacle avoidance mode in response to the shutdown command.

28. The aerial vehicle of claim 16, the processor further performing:
generating the shutdown command for the obstacle avoidance mode in response to detecting the aerial vehicle being in the shuttle mode; and,
switching off the obstacle avoidance mode in response to the shutdown command.

29. A flight control apparatus, comprising:
a communication connection establishing module for establishing a communication connection with a control device;
a shutdown command receiving module for receiving a shutdown command for an obstacle avoidance mode transmitted by the control device through the communication connection, the shutdown command being generated when the control device detects a clicking operation of a button; and,
an obstacle avoidance mode turning off module for switching off the obstacle avoidance mode in response to the shutdown command.
